(19) United States
(12) Patent Application Publication
(10) Pub. No.: US 2010/0007584 A1
(43) Pub. Date: Jan. 14, 2010

(54) ELECTRON SOURCE AND IMAGE DISPLAY APPARATUS

(75) Inventor: Tomoya Onishi, Ayase-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/487,823

(22) Filed: Jun. 19, 2009

(30) Foreign Application Priority Data
Jul. 11, 2008 (JP) 2008-181504

(51) Int. Cl. G09G 3/20

(52) U.S. Cl. 345/55

(57) ABSTRACT

An electron source has a plurality of electron-emitting devices, a plurality of scanning wirings and a plurality of modulation wirings which connect the plurality of electron-emitting devices into a matrix pattern, a scanning wiring connecting electrode which connects the electron-emitting device and the scanning wiring, a modulation wiring connecting electrode which connects the electron-emitting device and the modulation wiring, and a bypass wiring which is insulated from the scanning wiring and the modulation wiring and is arranged in parallel with the scanning wiring or the modulation wiring. The connecting electrode of any one of the scanning wiring connecting electrode and the modulation wiring connecting electrode, which is closer to the bypass wiring, has an overcurrent suppressing portion which suppresses flowing of a certain or more electric current to the connecting electrode.

### BACKGROUND OF THE INVENTION

1. Field of the Invention

The present invention relates to an electron source and an image display apparatus having the electron source.

2. Description of the Related Art

In image display apparatuses having electron-emitting devices, electrons emitted from the electron-emitting devices are accelerated by an anode electrode to which a high voltage is applied, and collide with a phosphor so that the phosphor emits light. The electron-emitting devices are connected into a matrix pattern by scanning wirings and modulation wirings, and electrons are emitted from the plurality of electron-emitting devices so that images are displayed by the image display apparatus.

Insides of image display apparatuses having the electron-emitting devices are generally maintained at high vacuum. A high voltage is applied to the anode electrodes as described above. For this reason, the wirings such as scanning wirings and signal wirings, and the electron-emitting devices are exposed to a high electric field. Therefore, when a triple point or foreign matters where an electric field concentrates are present in the electron-emitting devices and the wirings, these places become electric field concentration points, and thus electricity is occasionally discharged in the vacuum of the image display apparatuses.

When electricity is discharged, electric charges accumulated on the anode electrode flow into the electron-emitting devices and the wirings, and flow also into a driving circuit connected with the wirings. This likely causes breakage of the driving circuit.

When a high electric current flows into the wirings such as the scanning wirings and signal wirings and an electric potential of the wirings rises, an excessive voltage is applied to the electron-emitting devices connected to the wirings. As a result, a plurality of electron-emitting devices connected to one wiring is broken, and a sequential pixel defect likely occurs.

In order to suppress such an overcurrent caused by the electric discharge, a constitution where an overcurrent preventing film is provided is proposed (see Japanese Patent Application Laid-Open No. 9-298030).

### SUMMARY OF THE INVENTION

It is an object of the present invention to provide a new electron source and a new image display apparatus which are capable of suppressing breakage of electron-emitting devices caused by electric discharge.

The electron source according to the present invention includes: a plurality of electron-emitting devices; a plurality of scanning wirings and a plurality of modulation wirings which connect the plurality of electron-emitting devices into a matrix pattern; a scanning wiring connecting electrode which connects the electron-emitting device and the scanning wiring; a modulation wiring connecting electrode which connects the electron-emitting device and the modulation wiring; and a bypass wiring which is insulated from the scanning wiring and the modulation wiring and are arranged in parallel with the scanning wiring or the modulation wiring, wherein the connecting electrode of any one of the scanning wiring connecting electrode and the modulation wiring connecting electrode, which is closer to the bypass wiring, has an overcurrent suppressing portion which suppresses flowing of a certain or more electric current to the connecting electrode.

The present invention can suppress breakage of electron-emitting devices caused by electric discharge. Further features of the present invention will become apparent from the following description of exemplary embodiments with reference to the attached drawings.

### BRIEF DESCRIPTION OF THE DRAWINGS

FIG. 1 is a perspective view illustrating one example of a constitution of an image display apparatus;

FIG. 2 is a pattern diagram illustrating an electric source;

FIG. 3 is a diagram illustrating a constitution of an electron-emitting device;

FIGS. 4A to 4C are diagrams illustrating a constitution of an overcurrent suppressing portion; and

FIGS. 5A to 5I are diagrams illustrating a method of manufacturing the electron source.

### DESCRIPTION OF THE EMBODIMENTS

Embodiments of the present invention are described below with reference to the drawings.

### First Embodiment

### (Constitution of Image Display Apparatus)

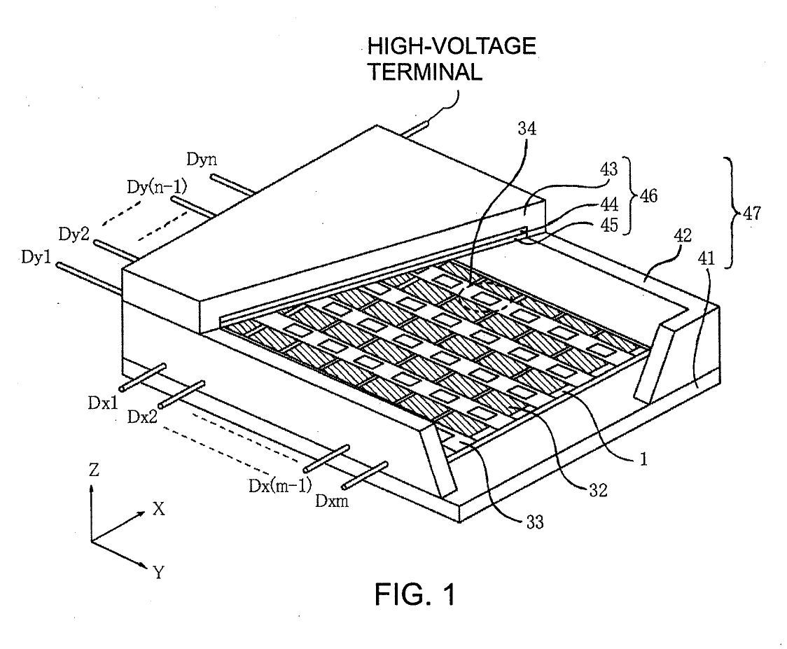

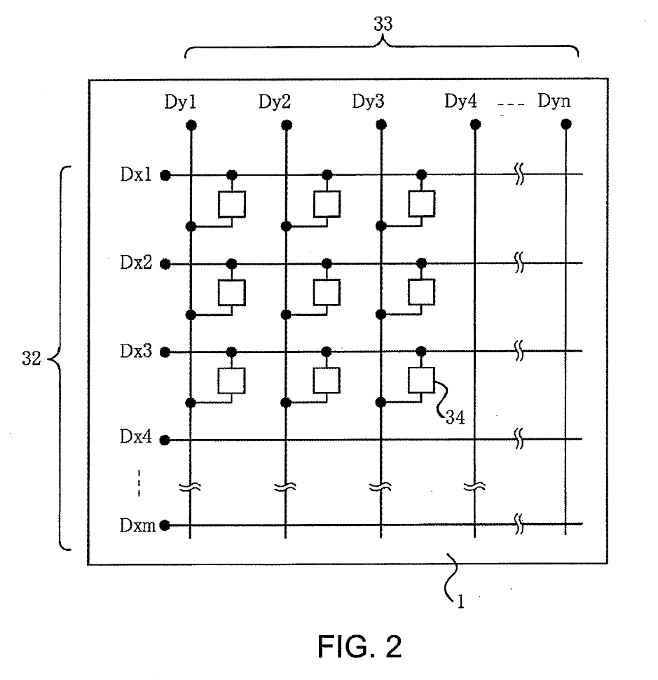

An image display apparatus having an electron source provided with a plurality of electron-emitting devices according to the present invention is described with reference to FIGS. 1 and 2.

FIG. 1 is a perspective view illustrating one example of a constitution of the image display apparatus according to the first embodiment, and the apparatus is partially broken away in order to show its internal constitution. In the drawing, a substrate 1, scanning wirings 32, modulation wirings 33, and electron-emitting devices 34 are provided. The substrate 1 is fixed to a rear plate 41, and a face plate 46 is constituted so that a phosphor 44 and a metal back 45 as an anode electrode are formed on an inner surface of a glass substrate 43. The rear plate 41 and the face plate 46 are mounted to a support frame 42 via a frit glass or the like, so that an envelope 47 is constituted. Since the rear plate 41 is provided mainly in order to reinforce the strength of the substrate 1, when the substrate 1 itself has sufficient strength, the independent rear plate 41 is not necessary. When a support body called a spacer, not shown, is provided between the face plate 46 and the rear plate 41, the constitution of the apparatus has sufficient strength against atmospheric pressure.

M scanning wirings 32 are connected to terminals Dx1, Dx2, . . . Dxm. N modulation wirings 33 are connected to terminals Dy1, Dy2, . . . Dyn (m and n are positive integers) An interlayer insulating layer, not shown, is provided between the m-number of scanning wirings 32 and the n-number of modulation wirings 33, so as to electrically separate them from each other.

A high-voltage terminal is connected to the metal back 45, and a DC voltage of 10 [kV], for example, is applied. This is an acceleration voltage that gives energy sufficient for exciting a phosphor to electron beams emitted from the electron-emitting devices.

FIG. 2 is a pattern diagram illustrating the electron source according to the first embodiment. The electron source according to the first embodiment has a plurality of electron-emitting devices 34 which is connected into a matrix pattern by the scanning wirings 32 and the modulation wirings 33.

A scanning circuit (not shown), which applies a scanning signal for selecting a row of the electron-emitting devices 34 arranged in an X direction, is connected to the scanning wirings 32. On the other hand, a modulating circuit (not shown), which modulates each column of the electron-emitting devices 34 arranged in a Y direction according to an input signal, is connected to the modulation wirings 33. Driving voltages to be applied to the electron-emitting devices are supplied as difference voltages between scanning signals and modulation signals to be applied to the electron-emitting devices.

Examples of the electron-emitting devices 34 are surface conduction electron-emitting devices, Spindt type electron-emitting devices, metal insulator metal (MIM) electron-emitting devices, carbon nanotube electron-emitting devices, Ballistic electron surface-emitting display (BSD) electron-emitting devices. A constitution of the electron source in the case where the surface conduction electron-emitting devices are used as the electron-emitting devices 34 is described in detail below.

(Constitution of the Electron-Emitting Device)

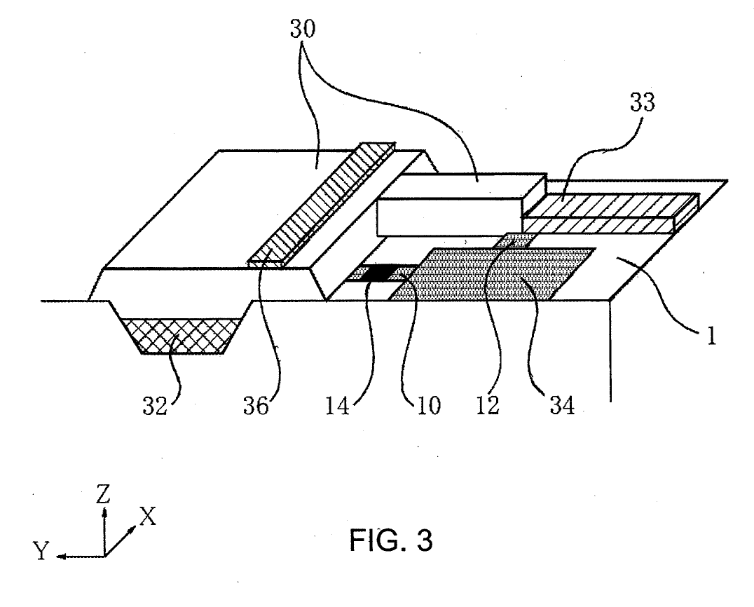

FIG. 3 is a diagram illustrating the constitution of the electron-emitting device according to the first embodiment.

Metal such as Ag, Cu, Al, Au or Pt, or metal oxide such as ITO, ATO, SnO₂ or ZnO is used for the scanning wirings 32 and the modulation wirings 33. The wirings 32 and 33 can be formed by a photolithography method, or a printing method using conductive paste. The direction of the scanning wirings is the X direction, the direction of the modulation wirings is the Y direction, and a normal line direction of the substrate 1 is a Z direction.

A scanning wiring connecting electrode 10 electrically connects the electron-emitting devices 34 and the scanning wirings 32. A modulation wiring connecting electrode 12 electrically connects the electron-emitting devices 34 and the modulation wirings 33. Metal such as Ag, Cu, Al, Au or Pt, or metal oxide such as ITO, ATO, SnO₂ or ZnO is used for the connecting electrodes 10 and 12. The connecting electrodes 10 and 12 can be formed by the photolithography method, or the printing method using conductive paste. The connecting electrodes 10 and 12 can be suitably formed by particularly the photolithography method because a pattern finer than the wirings is necessary.

In the first embodiment, bypass wirings 36 are formed so as to be parallel with the scanning wirings 32. The bypass wirings 36 are preferably grounded. The bypass wirings 36 should be a low-resistant member, and metal such as Ag, Cu, Al, Au or Pt, or metal oxide such as ITO, ArC, SnO₂ or ZnO is used. The bypass wirings 36 can be formed by the photolithography method, or the printing method using conductive paste. When electricity is discharged in the image display apparatus, a discharge current is allowed to flow into a ground potential via the bypass wirings 36, so that a sequential pixel defect or the breakage of the driving circuit caused by the discharge current can be suppressed.

The bypass wirings 36 are insulated from the scanning wirings 32 and the modulation wirings 33 by insulating layer 30. Ceramics such as glass frit or alumina, or SiO₂ can be used for the insulating layer 30. The insulating layer 30 can be formed by the photolithography method or the printing method.

In the first embodiment, an overcurrent suppressing portion 14 is provided on a part of the scanning wiring connecting electrode 10. Before a relationship between tho overcurrent suppressing portion 14 and the bypass wirings 36 is described, a phenomenon of the electric discharge that happens inside the image display apparatus is described in detail.

The electric discharge occurs inside the image display apparatus having the electron source becomes arc discharge such that the rear plate 41 and the face plate 46 short-circuit in a moment. It is considered that the arc discharge allows an electrode material on the surface of the rear plate on a cathode side to evaporate and generate plasma, so that the electric discharge is maintained. That is to say, it is considered a cathode spot is generated near an area where the electrode material is evaporated. Therefore, when the discharge current flows into the electron-emitting devices or the wirings, the cathode spot can be moved by forming an area where the electrode material is easily evaporated, on a route where the discharge current flows.

The cathode spot is not fixed at one spot but moves due to an influence of ambient potential distribution. When the wirings are near the area where the electrode material is easily evaporated, the discharge current flows into the wirings.

In the first embodiment, the overcurrent suppressing portion 14 is provided on the scanning wiring connecting electrode 10 of any one of the scanning wiring connecting electrode 10 and the modulation wiring connecting electrode 12, which is a connecting electrode positioned closer to the bypass wirings 36. The overcurrent suppressing portion 14 suppresses flowing of a certain or more electric current to the scanning wiring connecting electrode 10.

The overcurrent suppressing portion 14 preferably melts or evaporates at the time of the electric discharge so that heat breaking easily occurs therein.

In order to make the overcurrent suppressing portion easily melt, a material whose melting point is lower than that of the scanning wiring connecting electrode 10 can be used as the overcurrent suppressing portion 14. For example, W, Mo, Cr, Pr, Ti, Cu, Au or Ag is used for the scanning wiring connecting electrode 10, and Al, Zn, Sn or In can be used for the overcurrent suppressing portion 14.

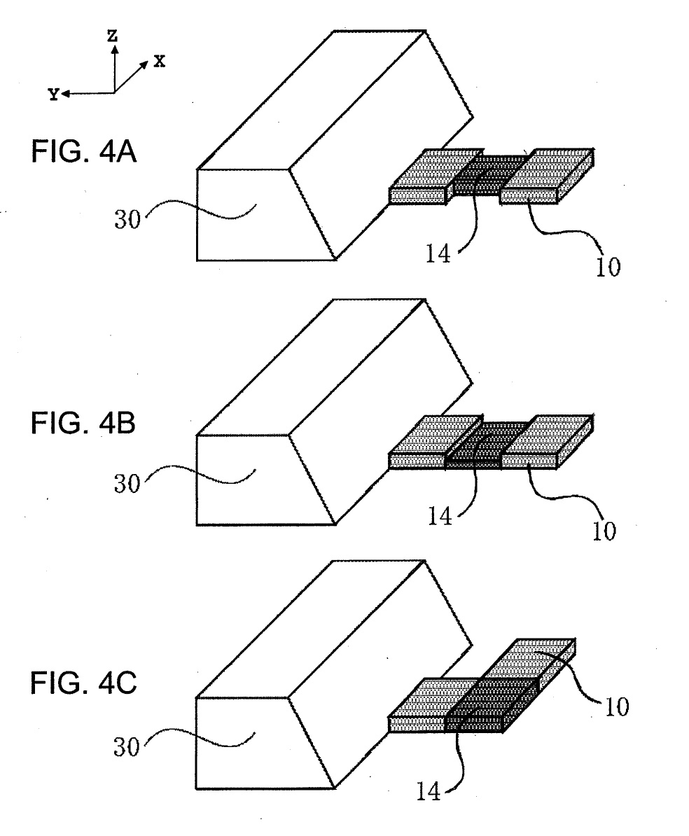

In order to make the overcurrent suppressing portion 14 to easily generate heat, resistance of the overcurrent suppressing portion 14 can be set to be higher than that of the scanning wiring connecting electrode 10, or the electric current can be allowed to concentrate. For example, a high-resistant material can be used as the material of the overcurrent suppressing portion 14. A metal oxide is suitably used as the high-resistant material, and ITO, ATO, ZnO or SnO can be used. The overcurrent suppressing portion 14 can be constituted so that electric current easily concentrate. As shown in FIG. 4A, for example, a width of the overcurrent suppressing portion 14 is set to be smaller than a width of the scanning wiring connecting electrode 10. As shown in FIG. 4B, a thickness of the overcurrent suppressing portion 14 can be set to be smaller than a thickness of the scanning wiring connecting electrode 10. As shown in FIG. 4C, a part of the scanning wiring connecting electrode 10 may be constituted so that an electric current easily concentrates. This is because a temperature of the overcurrent suppressing portion 14 is locally heightened due to the concentration of the electric current, and it easily generates heat. Further, the constitutions shown in FIGS. 4A to 4C may be combined.

According to the first embodiment, when electric discharge occurs and a discharge current flows into the overcurrent suppressing portion 14, the temperature of the overcurrent suppressing portion 14 rises and an electric potential also rises. When the overcurrent suppressing portion 14 melts or evaporates, a cathode spot is generated near the overcurrent suppressing portion 14. The cathode spot moves to the bypass wirings 36 provided near the overcurrent suppressing portion 14. The bypass wiring 36 is grounded, and the electric charges accumulated on the anode electrode 45 flow out via the bypass wiring 36, so that the electric discharge is ended. This can suppress the sequential pixel defect such that the discharge current flows into the scanning wiring 32 or the modulation wiring 33, and the plurality of electron-emitting devices connected to one wiring is broken. Further, this constitution can suppress breakage of the driving circuit due to the flowing of the discharge current into the driving circuit.

### Second Embodiment

In the first embodiment, the bypass wrings 36 are arranged so as to be parallel with the scanning wirings 32. The overcurrent suppressing portion 14 is provided to the scanning wiring connecting electrode 10 as the connecting electrode which is positioned closer to the bypass wirings 36 than the modulation wiring connecting electrode 12, but the present invention is not limited to such a constitution.

That is to say, the bypass wirings can be arranged so as to be parallel with the modulation wirings 33, and the overcurrent suppressing portion can be provided to the modulation wiring connecting electrode 12 as the connecting electrode positioned closer to the bypass wirings 36.

### Third Embodiment

In the first embodiment, the bypass wirings 36 are arranged so as to be parallel with the scanning wirings. At this time, the scanning wiring connecting electrode 10 is closer to the bypass wirings 36 than the modulation wiring connecting electrode 12, but the present invention is not limited to such a constitution.

That is to say, even when the bypass wirings 36 are arranged so as to be parallel with the scanning wirings, the modulation wiring connecting electrode 12 is likely closer to the bypass wirings adjacent to the bypass wirings 36 in FIG. 3. In this case, the overcurrent suppressing portion is provided to the modulation wiring connecting electrode 12.

### Fourth Embodiment

In the above embodiments, the overcurrent suppressing portion is provided to the scanning wiring connecting electrode 10 or the modulation wiring connecting electrode 12, but the present invention does not exclude a constitution that the overcurrent suppressing portion is provided to both the scanning wiring connecting electrode 10 and the modulation wiring connecting electrode 12.

When the overcurrent suppressing portion is provided to both the scanning wiring connecting electrode 10 and the modulation wiring connecting electrode 12, not only the bypass wirings parallel with the scanning wirings but also the bypass wirings which are parallel with the modulation wirings may be provided.

### EXAMPLES

Concrete examples of the present invention are described in detail below.

### Example 1

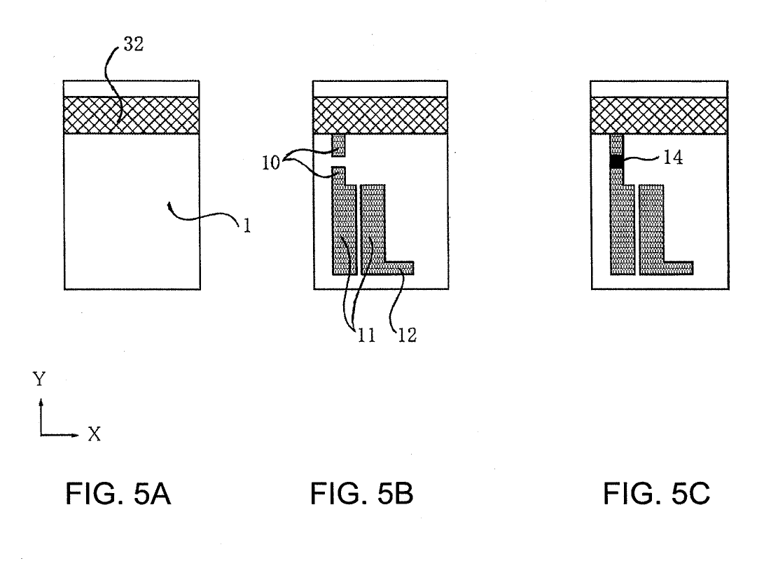

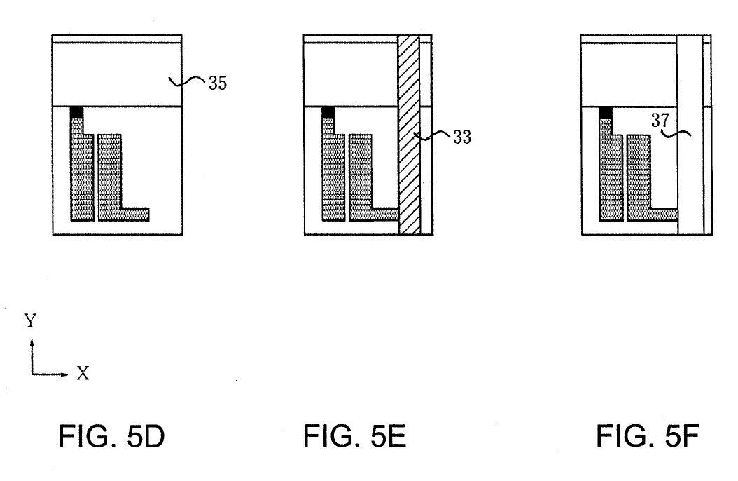

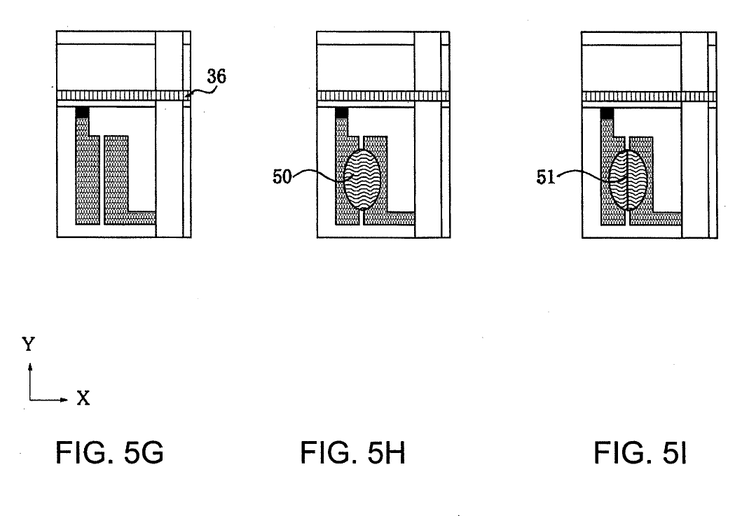

A method of manufacturing the electron source according to the example 1 is described with reference to FIG. 5.

(Step 1: Formation of Scanning Wiring)

A glass substrate PD 200 is used as the substrate 1 of the rear plate.

The scanning wirings 32 are formed on the substrate 1 (FIG. 5A). In the example 1, the scanning wirings 32 are embedded into the glass substrate 1 so as to be formed. The glass substrate 1 is laminated with dry film resist, and the portions where the scanning wirings are formed are exposed and developed. Thereafter, these portions are etched with hydrofluoric acid, so that grooves are formed on the substrate 1. An etching depth is 30 μm and a width is 200 μm. The dry film resist is peeled, and the scanning wirings 32 with thickness of 30 μm and width of 200 μm are formed by using paste composed of Ag particles, glass frit and resin binder according to a screen printing method. Thereafter, the substrate 1 is calcined at 450°.

(Step 2: Formation of Device Electrode and Connecting Electrode)

Device electrodes 11, the scanning wiring connecting electrode 10 and the modulation wiring connecting electrode 12 of the surface conduction electron-emitting devices (SCE) are formed by a lift-off method. Concretely, the substrate 1 is laminated with dry film resist, and patterns of the device electrodes 11 and the connecting electrodes 10 and 12 are exposed and developed so that Pt with thickness of 200 nm is deposited by sputtering. After the deposition, the dry film resist is peeled, and the device electrodes 11 and the connecting electrodes 10 and 12 are formed (FIG. 5B). Sheet resistance of the formed Pt electrode is 10 Ω/sq (ohms per square) or less.

(Step 3: Formation of the Overcurrent Suppressing Portion)

The overcurrent suppressing portion 14 is formed on a part of the scanning wiring connecting electrode 10. Concretely, a liquid where fine particles ITO are dispersed is formed on a desired place by an ink-jet method (FIG. 5C). Sheet resistance of the formed 170 film is about 1000 Ω/sq.

(Step 4: Formation of the Insulating Layer)

Since the scanning wirings 32 should be insulated from the modulation wirings 33 to be formed later, an insulating layer 35 is formed at least portions where the scanning wiring 32 and the modulation wiring 33 intersect (FIG. 5D). Low-melting-point glass frit is used as the material of the insulating layer 35. The paste formed by the glass frit and the resin binder is screen-printed, so that the insulating layer 35 having a width of 300 μm and a thickness of 10 μm is formed. Thereafter, the insulating layer 35 is calcined at 450° C.

In the example 1, the insulating layer 35 is formed so that the portions from which the scanning wirings 32 are exposed in the image display apparatus are not present and so as to cover the entire surface of the scanning wirings 32. Such a constitution enables the flowing of the discharge current directly into the scanning wirings 32 to be suppressed.

(Step 5: Formation of the Modulation Wiring)

The modulation wirings 33 which intersect the scanning wirings 32 are formed (FIG. 5E). The modulation wirings 33 having a thickness of 10 μm and a width of 30 μm are formed by using paste composed of Ag particles, glass frit and resin binder according to the screen printing method. Thereafter, the modulation wirings 33 are calcined at 450° C.

(Step 6: Formation of the Insulating Layer)

Since the modulation wirings 33 and the bypass wirings 36 to be formed later should be insulated from each other, the insulating layer 37 is formed at least on the portions where the modulation wirings 33 intersect the bypass wirings 36 (FIG. 5F). Low-melting-point glass frit is used as the material of the insulating layer 37. Paste composed of glass frit and resin binder is screen-printed, so that an insulating layer 37 having a width of 50 μm and a thickness of 10 μm is formed. Thereafter, the insulating layer 37 is calcined at 450° C.

In the example 1, the insulating layer 37 is formed so that portions from which the modulation wirings 33 are exposed in the image display apparatus are not present and so as to cover the entire surface of the modulation wirings 33. Such a constitution enables the flowing of the discharge current directly into the modulation wirings 33 to be suppressed.

A combination of the insulating layers 35 and 37 in the example 1 corresponds to the insulating layer 30 shown in FIG. 3.

(Step 7: Formation of the Bypass Wiring)

The bypass wirings 36 are formed so as to be parallel with the scanning wirings 32 (FIG. 5G). The bypass wirings 36 having a thickness of 10 μm and a width of 30 μm are formed by using the paste composed of Ag particles, glass frit and resin binder according to the screen printing method. Thereafter, the bypass wirings 36 are calcined at 450° C.

(Step 8: Formation of Device Film)

A device film 50 is formed by applying PdO by means of the ink-jet method (FIG. 5H).

Thereafter, forming and activating which are known as the method of manufacturing the surface conduction electron-emitting device are carried out so that an electron-emitting portion 51 is formed (FIG. 5I).

The image display apparatus shown in FIG. 1 is formed by using the rear plate formed by the above steps and the face plate formed separately. An anode voltage of 10 kV is applied to the metal back 45, so that the electron source is driven, and an image is displayed. When the anode voltage is heightened, the electric discharge occurs at 15 kV, but thereafter when an image is displayed at 10 kV, a defect hardly occurs.

### Example 2

The example 2 is different from the example 1 in that the constitution of FIG. 4A is used as the overcurrent suppressing portion 14. For this reason, since the steps other than steps 2 and 3 are similar to those in the example 1, the description thereof will not be repeated.

(Step 2: Formation of the Device Electrode, the Connecting Electrode and the Overcurrent Suppressing Portion)

The device electrodes 11, the scanning wiring connecting electrode 10, the modulation wiring connecting electrode 12 and the overcurrent suppressing portion 14 of the surface conduction electron-emitting device (SCE) are formed by the lift-off method. Concretely, the substrate is laminated with dry film resist, and patterns of the device electrodes 11, the connecting electrodes 10 and 12 and the overcurrent suppressing portion 14 are exposed and developed, and Pt is deposited by sputtering. The width of the connecting electrodes 10 and 12 is 50 μm, and the width of the overcurrent suppressing portion 14 is 25 μm smaller than the connecting electrode 10 and 12. After the deposition, the dry film resist is peeled, and the device electrodes 11, the connecting electrodes 10 and 12 and the overcurrrent suppressing portion 14 is formed.

In the example 2, since the overcurrent suppressing portion 14 is also formed simultaneously, the step 3 of the example 1 is not necessary, and thus the steps after the step 4 in the example 1 are executed.

The image display apparatus shown in FIG. 1 is formed by using the rear plate formed by the above steps and the face plate formed separately. An anode voltage of 10 kV is applied to the metal back 45 so that the electron source is driven, and an image is displayed. When the anode voltage is raised, the electric discharge occurs at 15 kV, but thereafter when the image is displayed at 10 kV, a defect hardly occurs.

### Example 3

The example 3 is different from the example 1 in that the constitution of FIG. 4B is adopted as the overcurrent suppressing portion 14. For this reason, since the steps other than the step 3 are similar to those in the example 1, the description thereof will not be repeated.

(Step 3: Formation of the Overcurrent Suppressing Portion)

The overcurrent suppressing portion 14 is formed on a part of the scanning wiring connecting electrode 10. Concretely, the substrate is laminated with dry film resist, and the pattern of the overcurrent suppressing portion 14 is exposed and developed, and Pt having a thickness of 70 nm is deposited by sputtering. After the deposition, the dry film resist is peeled, and the overcurrent suppressing portion 14 is formed (FIG. 4B).

The image display apparatus shown in FIG. 1 is formed by using the rear plate formed by the above steps and the face plate formed separately. An anode voltage of 10 kV is applied to the metal back 45 so that the electron source is driven, and an image is displayed. When the anode voltage is raised, the electric discharge occurs at 15 kV, but thereafter when the image is displayed at 10 kV, a defect hardly occurs.

### Example 4

The example 4 is different from the example 1 in that the constitution of FIG. 4C is adopted as the overcurrent suppressing portion 14. For this reason, since the steps other than the steps 2 and 3 are similar to those in the example 1, the description thereof will not be repeated.

(Step 2: Formation of the Device Electrode, the Connecting Electrodes and the Overcurrent Suppressing Portion)

The device electrodes 11, the scanning wiring connecting electrode 10, the modulation wiring connecting electrode 12 and the overcurrent suppressing portion 14 of the surface conduction electron-emitting devices (SCE) are formed by the lift-off method. Concretely, the substrate is laminated with dry film resist, and the patterns of the device electrodes 11, the connecting electrodes 10 and 12 and the overcurrent suppressing portion 14 is exposed and developed, and Pt is deposited by sputtering. The overcurrent suppressing portion 14 is formed on the scanning wiring connecting electrode 10 so that an electric current concentrates. After the deposition, the dry film resist is peeled, and the device electrodes 11, the connecting electrodes 10 and 12 and the overcurrent suppressing portion 14 are formed.

In the example 4, since the overcurrent suppressing portion 14 is also formed simultaneously at step 2, the step 3 in the example 1 is not necessary, and the steps after step 4 in the example 1 are executed.

The image display apparatus shown in FIG. 1 is formed by using the rear plate formed by the above steps and the face plate formed separately. An anode voltage of 10 kV is applied to the metal back 45 so that the electron source is driven, and an image is displayed. When the anode voltage is raised, the electric discharge occurs at 15 kV, but thereafter when the image is displayed at 10 kV, a defect hardly occurs.

While the present invention has been described with reference to exemplary embodiments, it is to be understood that the invention is not limited to the disclosed exemplary embodiments. The scope of the following claims is to be accorded the broadest interruption so as to encompass all such modifications and equivalent structures and functions.

This application claims the benefit of Japanese Patent Application No. 2008-181504, filed on Jul. 11, 2008, which is hereby incorporated by reference herein in its entirety.

What is claimed is:

1. An electron source comprising:
a plurality of electron-emitting devices;
a plurality of scanning wirings and a plurality of modulation wirings which connect the plurality of electron-emitting devices into a matrix pattern;
a scanning wiring connecting electrode which connects the electron-emitting device and the scanning wiring;
a modulation wiring connecting electrode which connects the electron-emitting device and the modulation wiring; and
a bypass wiring which is insulated from the scanning wiring and the modulation wiring and is arranged in parallel with the scanning wiring or the modulation wiring,
wherein the connecting electrode of the scanning wiring connecting electrode and the modulation wiring connecting electrode which is close to the bypass wiring has an overcurrent suppressing portion which suppresses flowing of a certain or more electric current to the connecting electrode.

2. An electron source according to claim 1, wherein the bypass wiring is grounded.

3. An electron source according to claim 1, wherein the overcurrent suppressing portion is an area whose melting point is comparatively low in the connecting electrode having the overcurrent suppressing portion.

4. An electron source according to claim 1, wherein the overcurrent suppressing portion is an area whose resistance is comparatively high in the connecting electrode having the overcurrent suppressing portion.

5. An electron source according to claim 1, wherein the overcurrent suppressing portion is an area whose thickness is comparatively small in the connecting electrode having the overcurrent suppressing portion.

6. An electron source according to claim 1, wherein the overcurrent suppressing portion is an area whose width is comparatively small in the connecting electrode having the overcurrent suppressing portion.

7. An image display apparatus comprising:
a rear plate which has the electron source according to claim 1; and
a face plate which has an anode electrode which accelerates electrons emitted from the electron source.
